(19) United States
(12) Patent Application Publication
(10) Pub. No.: US 2004/0210835 A1
(43) Pub. Date: Oct. 21, 2004

(54) Image processing apparatus having function for managing management information relating to managed devices, process method and recording medium for such management information

(75) Inventor: Akemi Kurumatani, Osaka (JP)

Correspondence Address: BURNS DOANE SWECKER & MATHIS L L P, POST OFFICE BOX 1404, ALEXANDRIA, VA, 22313-1404, US

(73) Assignee: MINOLTA CO., LTD.

(21) Appl. No.: 10/650,690

(22) Filed: Aug. 29, 2003

(30) Foreign Application Priority Data
Apr. 21, 2003 (JP) 2003-115519

(51) Int. Cl. G06F 17/00

(52) U.S. Cl. 715/513

(57) ABSTRACT

An image processing apparatus that stores XML management information relating to a managed device and including a first group and a second group of management information, the image processing apparatus: when receiving from a terminal device a transmission request of data used for displaying a first group of management information, reading the management information, reading a first XSLT style sheet that is used for displaying the first group of management information from a first XSLT storage unit, and transmitting the management information and the first XSLT style sheet; and when receiving from the terminal device a transmission request of data used for displaying a second group of management information, reading from a second XSLT storage unit a second XSLT style sheet that is used for displaying the second group of management information, and transmitting the second XSLT style sheet.

This application is based on an application No. 2003-115519 filed in Japan, the content of which is hereby incorporated by reference.

### BACKGROUND OF THE INVENTION

(1) Field of the Invention

The present invention relates to an image processing apparatus that has a function for managing management information relating to managed devices. The present invention also relates to a process method and a recording medium for such management information.

(2) Related Art

Recently, device management systems have been developed, in which management information that relates to each type of device is transmitted through a network such as the Internet, and the management information is subjected to centralized management of an image processing apparatus which operates as a management server. Examples of the device are an image forming apparatus, an image reading apparatus, and a digital multiple function peripheral (MFP).

In conventional device management systems, management information used to be managed in HTML (hypertext markup language) format, in most cases. These days, however, XML (extensive markup language) that is an extension of HTML has started to be commercially practical.

In a device management system that adopts XML, management information in XML format, and a style sheet that is used for displaying the management information and is in XSLT (extensive style sheet language transform) format are each stored in a single file, and when the management information is downloaded from the image processing apparatus being a management server to be displayed at the terminal, one way is to download both of a single file containing the entire XML and a single file containing the entire XSLT at a time for display.

However, as the increase, in number, of devices to be managed that are connected to the network, the amount and the kind of management information increase. Accordingly, the amount of data in the style sheet in XSLT format increases as well. In such a case, it will be too much burden for the network, if all of the XML-formatted file storing the entire management information and the XSLT-formatted file storing the entire style sheet are downloaded. In addition, this causes another problem that it takes up much time to display the management information at the side of the terminal device.

### SUMMARY OF THE INVENTION

The object of the present invention, in order to solve the stated problems, is to provide an image processing apparatus, a method, and a recording medium, that alleviate burden for the network, and expedite display of the management information at the terminal device.

The stated object is achieved by the image processing apparatus having: an XML storage section which stores therein, in XML format, management information that relates to a managed device, the management information including a first group and a second group of information; a first XSLT storage section which stores therein, in XSLT format, a first style sheet that is used for displaying the first group of information; a second XSLT storage section which stores therein, in XSLT format, a second style sheet that is used for displaying the second group of information; a first transmission section which transmits the management information and the first style sheet, when receiving from a terminal device a transmission request of data used for displaying the first group of information; and a second transmission section which transmits the second style sheet, when receiving from the terminal device a transmission request of data used for displaying the second group of information.

Moreover, the stated object is also achieved by the image processing apparatus having: an XML storage section which stores therein, in XML format, management information that relates to a managed device and is classified into at least a first group and a second group of information, each group of information being stored in a different file from one another; an XSLT storage section which stores therein, in XSLT format, at least one style sheet that is used for displaying management information; a first transmission section which, when receiving from a terminal device a transmission request of data used for displaying the first group of information, transmits a first XML file that is in the XML storage section and that contains the first group of information, and transmits a style sheet that is in the XSLT storage section and that corresponds to the first XML file; and a second transmission section which, when receiving from the terminal device a transmission request of data used for displaying the second group of information, transmits a second XML file that is in the XML storage section and that contains the second group of information.

### BRIEF DESCRIPTION OF THE DRAWINGS

These and other objects, advantages and features of the invention will become apparent from the following description thereof taken in conjunction with the accompanying drawings that illustrate a specific embodiment of the invention.

In the drawings:

FIG. 1 shows one example of the device management system, in structure, which includes a digital multiple function peripheral (MFP) that is one example of the image processing apparatus of the present invention;

FIG. 2 is a functional block diagram showing the structure of the MFP of the first embodiment;

FIG. 3 is a flowchart for explaining the operation performed by the control unit of the first embodiment;

FIGS. 4A and 4B show examples of screen displayed at the display unit of the PC, in the first embodiment;

FIG. 5 shows one example of the management information in XML format, which is stored in the management information storage unit;

FIG. 6 shows one example of style sheet, before being switched to another, that causes the screen shown in FIG. 4A to be displayed;

FIG. 7 shows one example of style sheet to being switched to;

FIG. 8 is a flowchart showing one example of the operation performed by the PC after launch of the browser, in the first embodiment;

FIG. 9 is a functional block diagram showing the structure of the MFP of the second embodiment;

FIG. 10 shows one example of style sheet in XSLT format used for displaying the divided XML files;

FIG. 11 shows a display screen realized by the style sheet of FIG. 10;

FIGS. 12A and 12B show examples of the divided management information in XML format;

FIG. 13 shows one example of the information on font supported by the printer, which is shown in XML format;

FIGS. 14A and 14B respectively show the management information after classified according to updating frequency;

FIGS. 15A and 15B respectively show different management information for each model;

FIG. 16 is a flowchart showing one example of the operation performed by the PC after launch of the browser, in the second embodiment.

### DESCRIPTION OF THE PREFERRED EMBODIMENTS

As follows, the image processing apparatus, the method, and the program that relate to the present invention are described by way of embodiments, and with reference to the drawings.

(The First Embodiment)

(1) The Entire Structure of the Device Management System

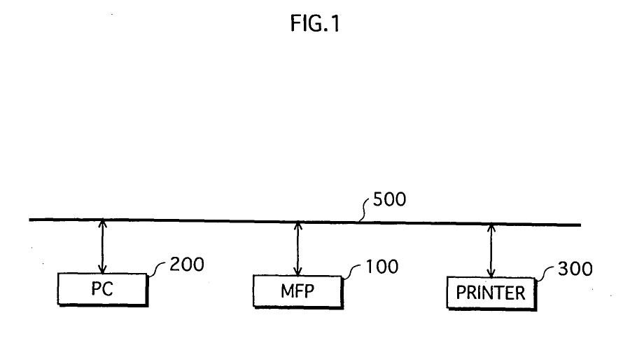

FIG. 1 shows one example of the device management system, in structure, that includes a digital multiple function peripheral (MFP) as one example of the image processing apparatus of the present invention.

In this embodiment, the device management system is structured such that an MFP100 and a PC200 are connected to a LAN (local area network) 500. The MFP100 operates as a server to manage management information transmitted by a managed device such as a printer 300, and the PC200 operates as a terminal apparatus that downloads the management information from the MFP100, and displays it. Note here that the managed device does not have to be connected to the LAN500, and may be alternatively connected to the Internet.

The MFP100 is operable to receive management information from a variety of image processing apparatus connected to the LAN500. Although not shown in the drawings, the image processing apparatus is a managed device which specifically is a printer, an image reading apparatus, and the like. Examples of the management information include data that represents status such as “out of paper”, “out of toner”, and the like, and data that manages printing jobs. Another example of the management information is data that represents information relating to the functions supported by each model (e.g. usable font). Details of the management information are described later, along with the description of the management method of the present embodiment.

(2) The Structure of the MFP100

As aforementioned, the MFP100 plays a role of a management server of the device management information. The following describes the structure of the part of the MFP100 that operates as the management server. Note that the MFP100 also operates as an image reading apparatus, a facsimile machine, a printer, and so on. However, the structure realizing these functions is already known, and so will not be detailed here.

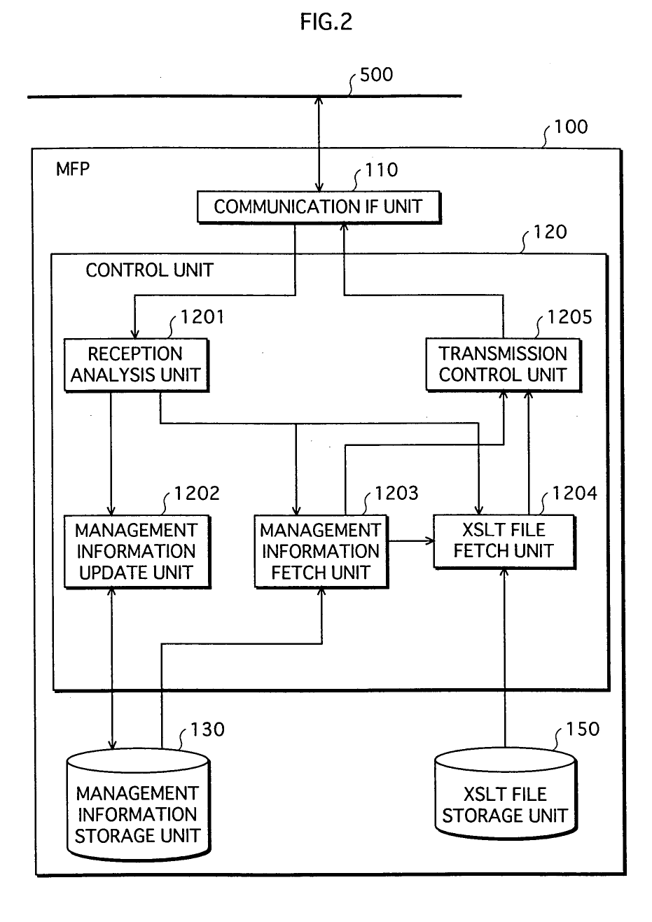

FIG. 2 is a functional block diagram showing the structure of the MFP100 of the present embodiment. The MFP100 includes a communication IF (interface) unit 110, a control unit 120, a management information storage unit 130, and an XSLT file storage unit 150.

The communication IF unit 110 performs communication control through the LAN 500, and an NIC (network interface card) may be adopted therefor for example.

The control unit 120 is mainly comprised of a CPU, and performs various types of controls. The controls performed by the control unit 120 include addition, rewriting, deletion, in XML format, directed to the management information transmitted from outside, according to an outside request (hereinafter these operations are collectively called “updating”). The controls also include a transmission control directed to the management information that is to be transmitted to an external device, and a transmission control directed to a style sheet in XSLT which is a style sheet language used for display of an XML management information.

The management information storage unit 130 is operable to store management information in XML format. The XSLT file storage unit 150 is operable to store a style sheet in XSLT (XSL transform) format, that is used to display management information at the display screen of the PC200. Note that the management information storage unit 130 and the XSLT file storage unit 150 may be integrated into a physically single storage apparatus (e.g. hard disk drive), not separate units from each other.

In response to a request from the PC200, the MFP100 of the present embodiment reads XML management information from the management information storage unit 130, and transmits the read XML management information to the PC200, and reads an XSLT style sheet from the XSLT file storage unit 150, and transmits the read XSLT style sheet to the PC200. In the first XML file to be transmitted to the PC200, the file name of an XSLT style sheet corresponding to the XML file is described and corresponded thereto.

The PC200 converts the received XML file into HTML (hypertext markup language) format, with reference to the contents of the corresponding XSLT, for display at the display means of a display apparatus and the like, by means of an application named as browser.

The control unit 120 includes, as functions, a reception analysis unit 1201, a management information update unit 1202, a management information fetch unit 1203, an XSLT file fetch unit 1204, and a transmission control unit 1205.

The reception analysis unit 1201 analyzes the contents of a signal transmitted from outside through the LAN500, and transmits the signal either to the management information update unit 1202 or to the management information fetch unit 1203. Specifically, when the management information is transmitted, as a signal, from an external managed device, the reception analysis unit 1201 transmits the management information to the management information update unit 1202, and the management information update unit 1202 updates the contents of the management information storage unit 130 in accordance with the received management information.

On the other hand, if the signal transmitted from outside represents a download request of XML management information, or an instruction to switch to another display format (i.e. switch to another XSLT used as a style sheet), the reception analysis unit 1201 transmits the signal to the management information fetch unit 1203. Note that an HTTP (hypertext transfer protocol) is used in communication of such as a download request for example.

In response to a download request, the management information fetch unit 1203 fetches XML management information from the management information storage unit 130, and informs the XSLT file fetch unit 1204 of the name of the corresponding XSLT file. The XSLT file fetch unit 1204 fetches, from among the plurality of style sheets stored in the XSLT file storage unit 150, a style sheet that corresponds to the XML file to be transmitted, and transmits the fetched style sheet.

Moreover, if a signal transmitted from outside indicates to switch to another style sheet, the reception analysis unit 1201 informs the XSLT file fetch unit 1204 of the file name for the style sheet to be switched to, included in the signal received from outside. The XSLT file fetch unit 1204 fetches the style sheet for this particular file name from the XSLT file storage unit 150, and transmits the style sheet to the PC200.

(3) The Operation Performed by the Control Unit 120 of the MFP100

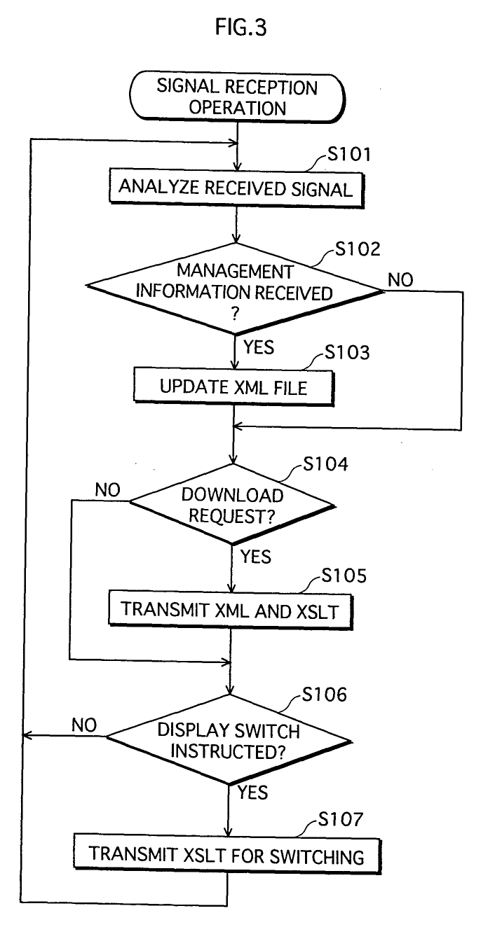

FIG. 3 is a flowchart for explaining the operation performed by the aforementioned control unit 120.

As shown in this drawing, at the control unit 120, the reception analysis unit 1201 first performs analyzing operation of a signal received from outside (S101), and if the received information is management information (S102:YES), the management information update unit 1202 updates the XML management information having been stored in the management information storage unit 130 (S103). Since the updating operation of XML files is already known, detailed explanation thereof is omitted here.

If the received signal is a download request from an external terminal device such as the PC200 (S102:NO, S104:YES), the management information fetch unit 1203 fetches XML management information from the management information storage unit 130, and the XSLT file fetch unit 1204 fetches a style sheet from the XSLT file storage unit 150, and both of the XML management information and the style sheet are transmitted to outside, via the transmission control unit 1205 and the communication IF unit 110 (S105).

If the received signal is a display switch instruction (i.e. instruction to switch to another style sheet) (S104:N0, S106:YES), the XSLT file fetch unit 1204 fetches the style sheet for switching, from the XSLT file storage unit 150, and transmits the style sheet for switching (S107).

Note that in the above, the updating operation for the XML file (S103) is performed prior to judgment as to whether there is a download request (that is S104). However, this updating operation may be performed, for example, subsequent to reception of a download request (S104:YES).

(4) One Example of Screen Displayed in the PC200

Here, one example of the screen display realized by performing the aforementioned operation is described.

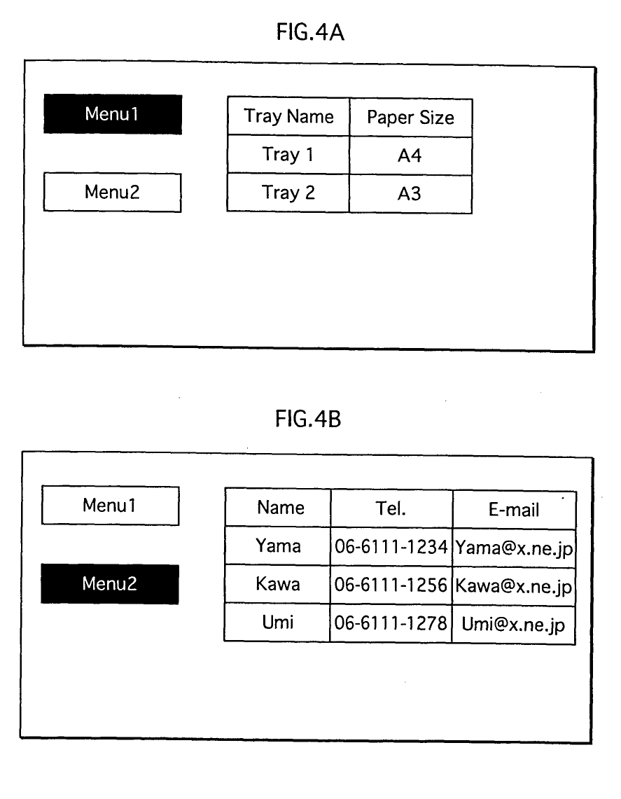

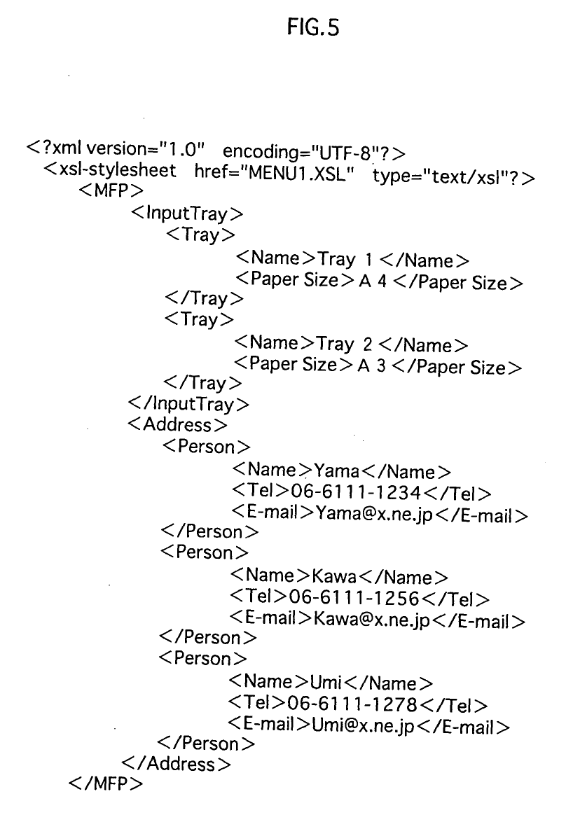

FIGS. 4A and 4B are diagrams showing examples of screen displayed at the display unit of the PC200. In the example, the management information storage unit 130 stores therein (1) a first group of management information that is information showing correspondence between numbers assigned for the trays of MFP100 in which paper for printing is set, and paper sizes (FIG. 4A, Menu 1), and (2) a second group of management information that is information showing users' names, telephone numbers, e-mail addresses (FIG. 4B, Menu 2). FIG. 4A and FIG. 4B are examples in which each item in these groups of management information is displayed by switching style sheets to be used. FIG. 5 is an example of the first management information and the second management information, that are stored in the management information storage unit 130.

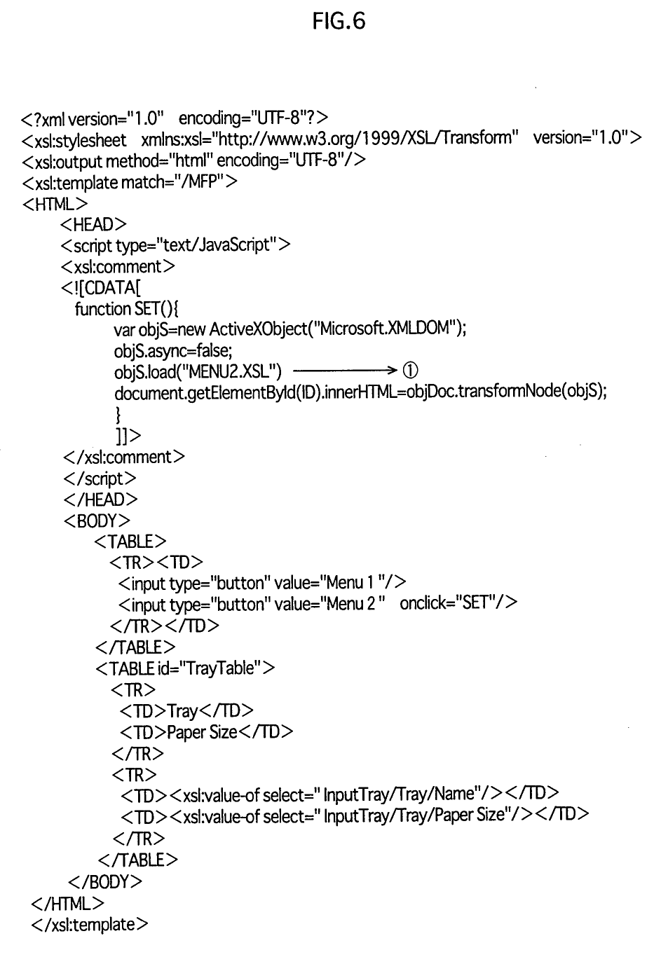

FIG. 6 shows one example of the style sheet before being switched to another (an XSLT style sheet that is used to realize switching), which is used to realize the screen display shown in FIG. 4A (i.e. the first group of management information). Here, the file name for the style sheet in FIG. 6 is “MENU1.XSL”, as described in the second line of the example of FIG. 5.

In the example of FIG. 6, it is defined to execute the function “SET” when the button for “Menu 2” is clicked. The style sheet to be switched to (file name: “MENU2.XSL”) is loaded at the line shown in (1) within the function “SET”.

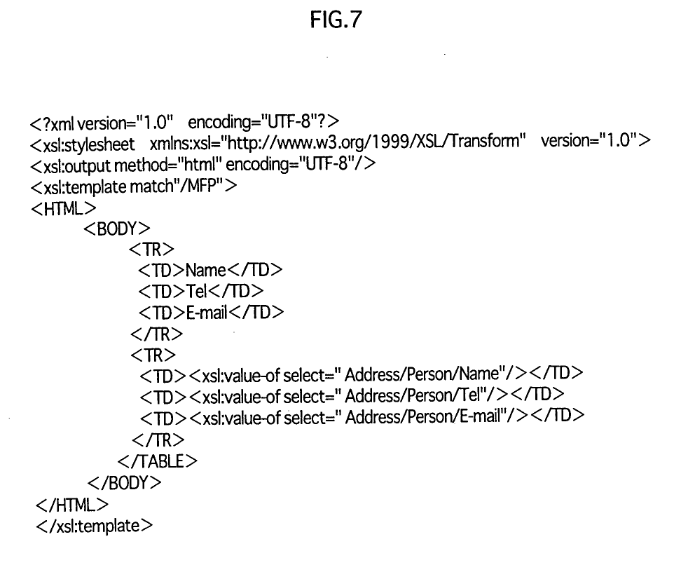

FIG. 7 is an example of the file of the style sheet to be switched to (i.e. a style sheet used for realizing the screen display shown in FIG. 4B, that relates to the second group of management information). This style sheet is synthesized with the XML management information shown in FIG. 5, and as a result, the screen of FIG. 4B is displayed.

Upon receiving a download request, from the PC200, that is specifically a transmission request of data used for displaying the first group of management information, the MFP100 transmits the management information (of FIG. 5) stored in the management information storage unit 130, and the style sheet (of FIG. 6) that is used for displaying the first group of management information and has been stored in the XSLT file storage unit 150.

If the button for “Menu 2” is clicked at the PC200, and if receiving an instruction for switching to another style sheet, the instruction being specifically a transmission request of data used for displaying the second group of management information, the MFP 100 transmits the style sheet (of FIG. 7) that is used for displaying the second group of management information and has been stored in the XSLT file storage unit 150.

Note that, upon receiving from a user through the browser screen, an instruction for displaying management information, the PC200 transmits every command representing a transmission request of a file that is in accordance with the received instruction (i.e. management information and/or a style sheet), as a transmission request of the aforementioned file. The instruction for displaying management information includes such as the aforementioned menu button being clicked or a predetermined input field receiving an input of predetermined contents corresponding to the display instruction (e.g. receiving an input of the address of the MFP100 at address field, or receiving an input of the desired file name).

Furthermore, in the aforementioned example, screen display is performed in the order of Menu 1 and Menu 2. However, if the PC designates Menu 2 first, then it is possible to display Menu 2 prior to Menu 1. Concretely, the style sheet of FIG. 6 is changed so that it is for displaying the information of Menu 2, and so that it includes description of a function by which the style sheet for displaying the information of Menu 1 is downloaded if the button for Menu 1 is clicked (third style sheet). In addition, the style sheet of FIG. 7 is changed so that it is for displaying the information of Menu 1 (fourth style sheet).

In this case, if receiving, as the designation of Menu 2, a transmission request of data used for displaying the first group of management information, the MFP100 transmits the management information (of FIG. 5) and the third style sheet. If receiving, as the designation of Menu 1, a transmission request of data used for displaying the second group of management information, the MFP100 transmits the fourth style sheet.

(5) The Operation Performed by the PC200

The following describes the operation performed by the PC200 when switching the style sheets as aforementioned.

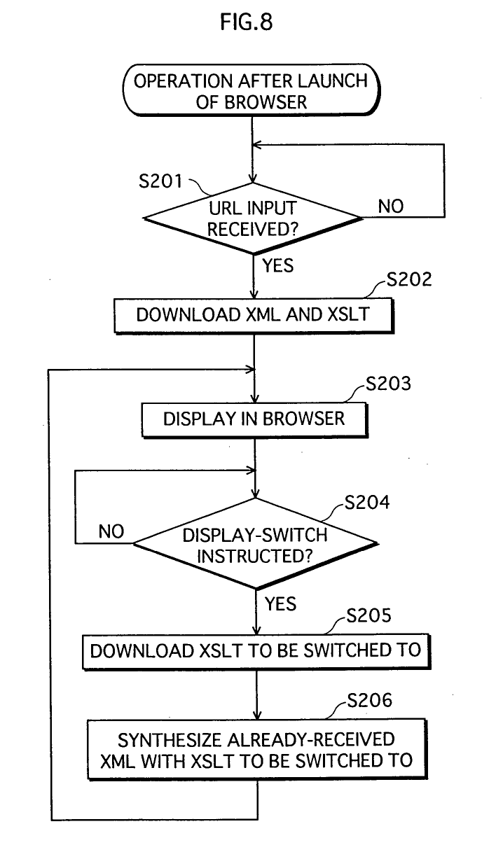

FIG. 8 is a flowchart showing one example of the operation performed by the PC200 after launch of a browser. As shown in this drawing, upon receiving the input of the URL (uniform resource locator) (S201:YES), the PC200 downloads the XML file containing the management information to be displayed thereat, together with the XSLT style sheet (S202), and displays them at the browser (S203).

Next, if receiving an instruction for display switch (i.e. a click of the bottom “Menu 2” in the example of FIG. 4) (S204:YES), the PC 200 downloads the XSLT to be switched to (“MENU2.XSL” in the example of FIG. 4) (S205), and synthesizes the downloaded XSLT with the already received XML (S206), and displays them at the browser (S203).

As described above, in the present embodiment, an XSLT style sheet is divided in parts in advance, and necessary parts are downloaded in response to a display-switch instruction. Therefore, it is unnecessary to download the style sheet having a large amount of data at a time, thereby alleviating the burden born by the network, and expediting the display switch.

(The Second Embodiment)

The following describes the second embodiment of the present invention. The aforementioned first embodiment is an example in which a display switch is performed using a plurality of XSLT style sheets for a single XML file. The present embodiment is an example of managing XML management information by dividing it into a plurality of files. Note here that the network system of the present embodiment is the same as shown in FIG. 1; however the operations performed by the MFP100 and by the PC200 are different from those of the first embodiment. Therefore, the differences will be mainly described as follows.

(1) The Structure of the MFP100

Also in the present embodiment, the MFP100 operates as a management server for the device management information. The following describes the structure of the part of the MFP 100 that operates as the management server.

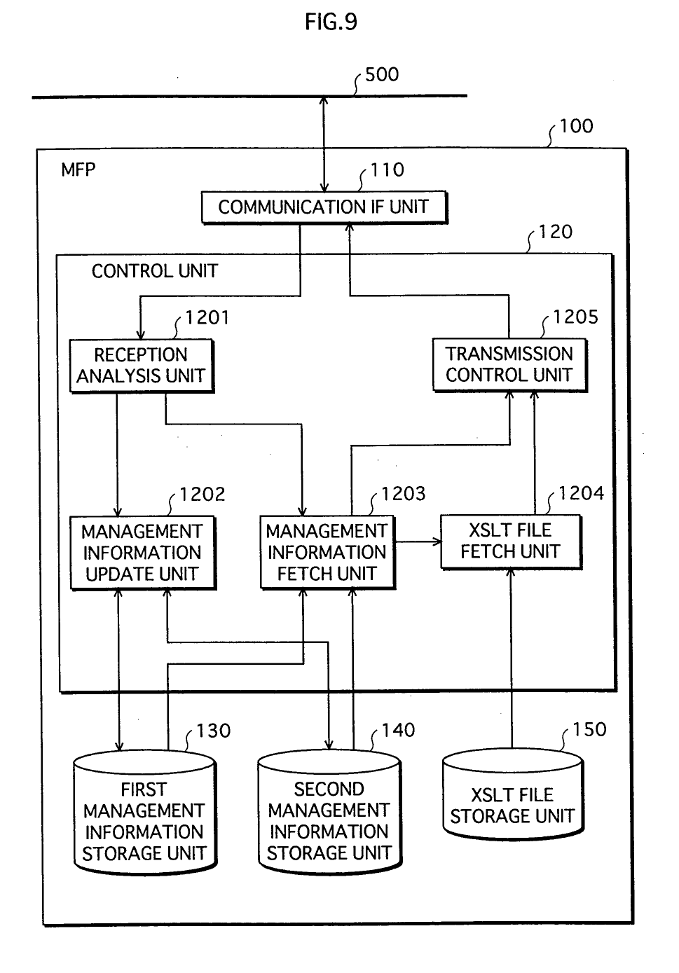

FIG. 9 is a functional block diagram showing the structure of the MFP100 of the present embodiment. The MFP100 of the present embodiment is different from that of the first embodiment, such as in that it is equipped with the second management information storage unit 140, in addition to the first management information storage unit 130, and in that the management information update unit 1202 updates the management information that has been divided into two, each piece having been stored separate in the first management information storage unit 130 and in the second management information storage unit 140. That is, the present embodiment is characterized in that the XML management information is managed by being divided into a plurality of XML files, according to a predetermined condition. Note that a single storage apparatus (such as a hard disk drive) may be used for all of the first management information storage unit 130, the second management information storage unit 140, and the like, just as in the first embodiment.

The control unit 120 includes a reception analysis unit 1201, a management information update unit 1202, a management information fetch unit 1203, an XSLT file fetch unit 1204, and a transmission control unit 1205, just as the control unit 120 of the first embodiment. In the present embodiment, the management information update unit 1202 updates the contents of the first management information storage unit 130, or the contents of the second management information storage unit 140, according to the received management information.

If a signal transmitted from outside is a download request of an XML file (i.e. a transmission request of data used for displaying the management information), the control unit 120 transmits the signal to the management information fetch unit 1203. The management information fetch unit 1203, in turn, fetches the requested XML file from one of the first management information storage unit 130 and the second management information storage unit 140, and transmits the XML file to outside via the transmission control unit 1205. Note that in the XML file that the management information fetch unit 1203 fetches, the file name of the corresponding XSLT file is described. Therefore, the XSLT file fetch unit 1204 can fetch the style sheet corresponding to the file name described in the fetched XML file, and transmit the style sheet to the PC200. By this, both of the XML file and the XSLT style sheet are divided in parts, which further alleviates the burden born by the network.

(2) Examples of the Style Sheet

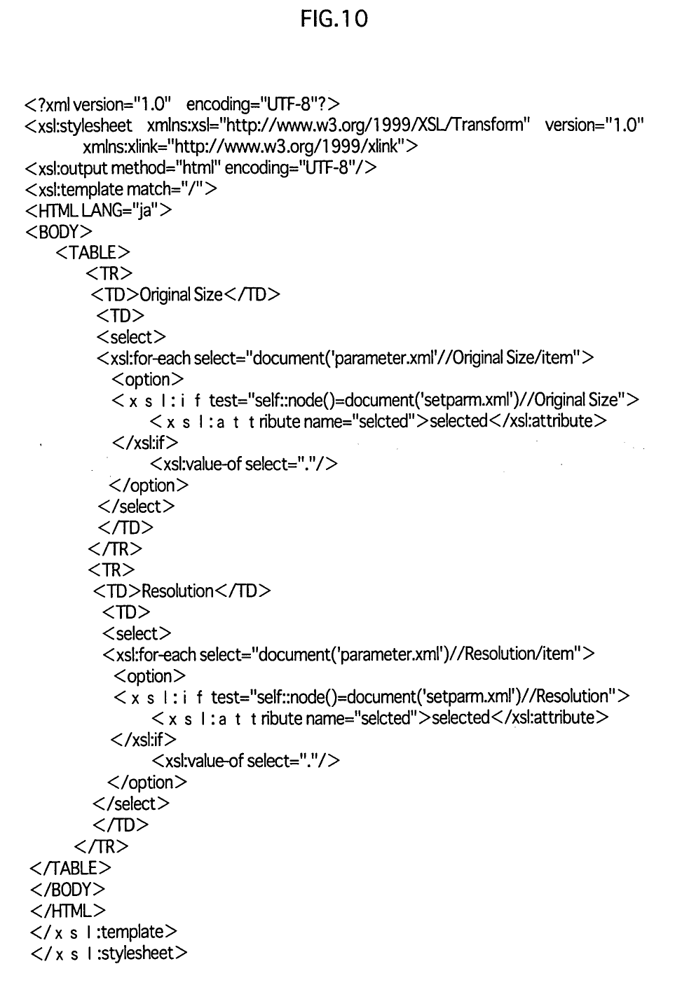

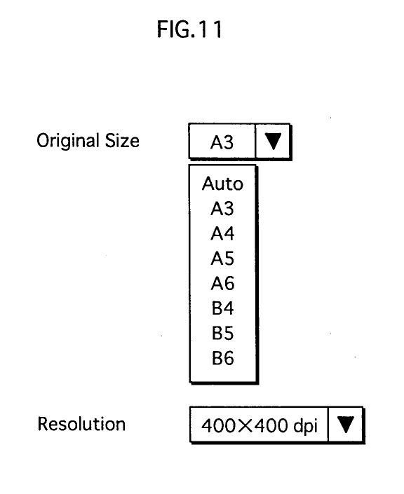

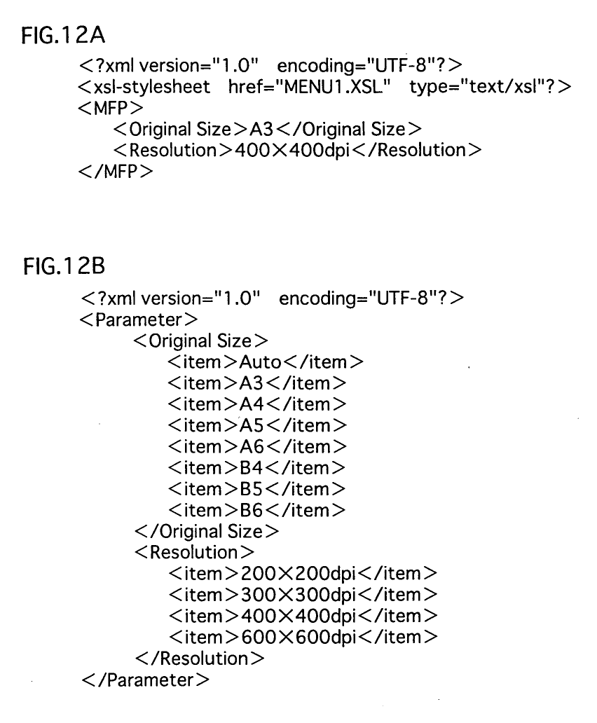

Next, concrete examples of the style sheet of the present embodiment are described as follows. FIG. 10 shows one example of the XSLT style sheet used for displaying XML files that resulted from dividing in the present embodiment. FIG. 11 shows a display screen realized by the style sheet of FIG. 10, and FIGS. 12A and 12B show examples of the contents of the divided XML file.

In this example, management information is divided into two files; (1) a file that contains data representing paper size and resolution level, that have been set, (shown in FIG. 12A as file name: “SETPARM.XML”), and (2) a file that contains data representing all the paper sizes and resolution levels, that are settable (shown in FIG. 12B as file name: “PARAMETER.XML”). According to this construction, it becomes possible to download the PARAMETER.XML file, only when necessary. This will help alleviate the burden born by the network.

(3) The Storing Method of Management Information at the MFP100

The following describes a method of dividing management information so as to store divided management information respectively in the first management information storage unit 130 and in the second management information storage unit 140.

(3-1) Classification by Display Frequency

The first method of classifying management information is to classify management information by the display frequency at the terminal apparatus such as the PC200, by which management information that is hardly displayed (first group of management information) are to be downloaded only upon request, and information that is frequently displayed (second group of management information) is for example downloaded in the first place. According to this method, it becomes possible to alleviate the burden born by the network, compared to when the entire management information is downloaded at once, and at the same time, it becomes possible to expedite the display of the management information that is displayed frequently.

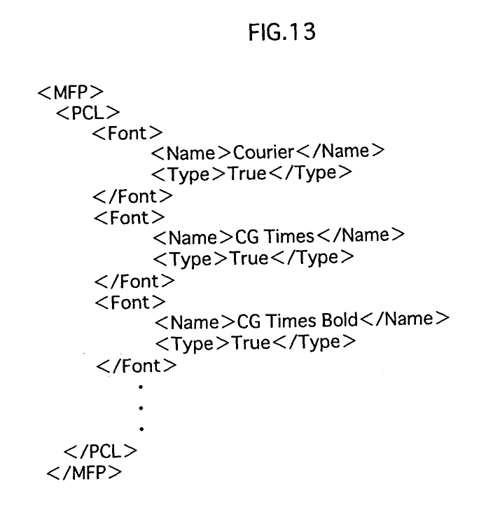

Note here that one example of management information that is hardly displayed is information on font that is supported by the printer (refer to FIG. 13). One example of management information that is frequently displayed is information always displayed when performing printing such as information about initial value of the paper tray for printing and the like. Another example of the latter kind of management information is information displayed, in switching between print conditions, such as information about the other paper trays, and about supported resolution levels.

(3-2) Classification by Updating Frequency

The second method of classifying management information is to divide management information by the updating frequency thereof. Some types of management information are rarely updated after being set once, such as types of font supported by the printer having been aforementioned (first group of management information). Other types of management information are very frequently updated, such as history information of printing jobs (second group of management information).

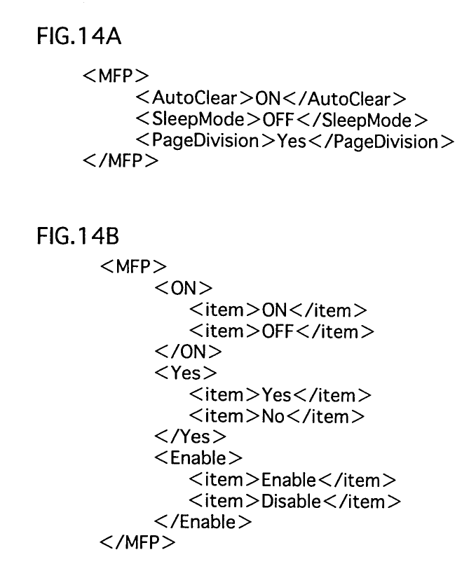

FIGS. 14A and 14B show examples of the management information classified by updating frequency.

FIG. 14A shows information representing a status of the MFP, whose updating frequency is relatively high. On the other hand, FIG. 14B represents kinds of setting values commonly used by each model, which will be rarely updated (the setting conditions are either “ON” or “OFF”).

Note that other examples of management information whose updating frequency is high are status information for each managed device (including error information such as “out of paper”, and “out of ink”), printing-job information (history information such as on file name and reception time). It is advantageous to manage status information on managed devices in a separate file, because for example it simplifies server operations in a case when only the status information is required to be automatically updated. Likewise, it is advantageous to manage printing-job information in a separate file, because for example it becomes easier to use the printing-job information on a different application when history management is performed for the printing jobs.

(3-3) Other Classifications

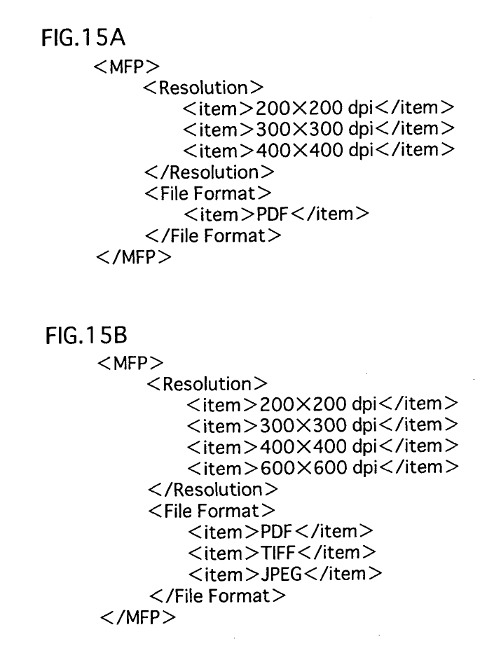

Other classification methods include classification according to model. FIG. 15 is a diagram showing examples of management information different for each model. In this example, each file has a settable resolution level and file format according to a model.

Note that such a classification method is also applicable to the XML management information of the first embodiment. For example, the first group of management information and the second group of management information are each categorized as frequently updated management information and rarely updated management information, respectively. If receiving a transmission request of data used for displaying the first group of management information (i.e. frequently updated management information), the MFP100 transmits the management information including both of the first and second groups of management information, and the style sheet for displaying the first group of management information. If receiving a transmission request of data used for displaying the second group of management information (i.e. rarely updated management information), the MFP100 transmits the style sheet for displaying the second group of management information.

(4) The Operation Performed by the PC200

Next, the following describes the operation performed by the PC200 of the present embodiment.

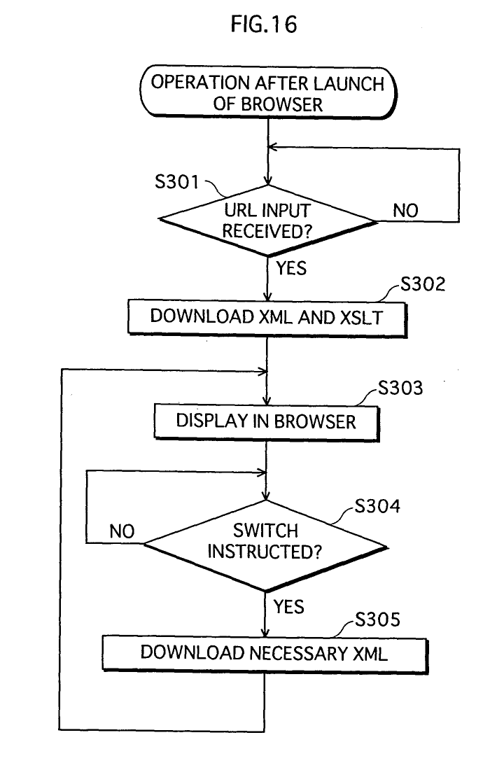

FIG. 16 is a flowchart showing the operation performed by the PC200. This embodiment is different from the first embodiment in that, when receiving an instruction for switching (S304:YES), the necessary XML file is downloaded (S305), for display at the browser.

As aforementioned, in this case too, the XML management information may be managed by being divided into files according to each category, so as to be downloaded file by file. This alleviates the burden for the network.

As for the style sheet in this case, it may be divided and stored to files. Alternatively, another structure is also possible in which one style sheet may be used for displaying the divided management information. In such a structure, it is likely that the style sheet cannot be divided. However, since at least the management information is downloaded file by file, there will still be an effect of alleviating the burden of the network.

Note that the program realizing the image processing apparatus and the terminal apparatus that the present invention relates to, may be recorded on varieties of recording media from which data can be read with use of a computer. Such recording media include: magnetic tape, a magnetic disc such as a flexible disc, optical discs such as a DVD, a CD-ROM, a CD-R, an MO, and a PD, and flash memory type recording media such as Smart Media (registered trademark), and COMPACTFLASH (registered trademark). The program may be produced and transferred, in the form of the aforementioned recording media. Alternatively, the program may be transmitted, in the form of the program itself, via a variety of wired/wireless network including the Internet, a broadcast, an electric communication circuit, and satellite communication, for supply.

Furthermore, the program of the present invention does not always have to include all of the modules for making a computer execute the aforementioned operations; for example, varieties of general programs individually installable to an information processing apparatus may be used to make a computer execute each operation of the present invention. The general programs include such as a communication program, and a program included in the operating system (OS). This means that the recording medium of the present invention does not have to contain all the aforementioned modules, nor transmit all the aforementioned modules. Still Further, a predetermined operation may be sometimes executed using dedicated hardware.

<Modifications>

So far, the present invention has been described by way of various kinds of embodiments; however, needless to say, the present invention is not limited to the specific examples shown by the aforementioned embodiments, and may include the following modification examples.

(1) In the aforementioned embodiments, the MFP plays a role of a device management server. However, not limited to such, a variety of image processing apparatus may play such a role, such as a printer and a scanner.

(2) In addition, in the aforementioned embodiments, XML management information is synthesized with an XSLT style sheet (e.g. change into HTML format) at the PC200 side. However, such a synthesizing operation may also be performed at the management server side.

(3) Although not described in the embodiments, there is a possibility that, when receiving a download request from the terminal apparatus such as the PC200, the image processing apparatus such as the MFP100 is suffering from a problem (abnormal state that includes inconsistency between pieces of management information). In such a case, it may be arranged so that a message reporting thereof is sent to the terminal apparatus.

That is, it is possible that an apparatus may have a structure in that judgment is performed as to the state of the apparatus itself (whether abnormal state exists), and if an abnormal state is detected in the apparatus, the apparatus sends a message reporting of the abnormal state to a terminal apparatus. This structure will realize such as that, when an inconsistency of contents results between pieces of management information, a message reporting thereof can be transmitted, which helps heighten the practicality. Note that as for judgment of state, methods therefor include such as in which judgment results in abnormal state if detecting a case in which data representing management information is not in conformity with as predetermined.

Although the present invention has been fully described byway of examples with references to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. An image processing apparatus comprising:
an XML storage section which stores therein, in XML format, management information that relates to a managed device, the management information including a first group and a second group of information;
a first XSLT storage section which stores therein, in XSLT format, a first style sheet that is used for displaying the first group of information;
a second XSLT storage section which stores therein, in XSLT format, a second style sheet that is used for displaying the second group of information;
a first transmission section which transmits the management information and the first style sheet, when receiving from a terminal device a transmission request of data used for displaying the first group of information; and
a second transmission section which transmits the second style sheet, when receiving from the terminal device a transmission request of data used for displaying the second group of information.

2. The image processing apparatus of claim 1, further comprising:
a state detection section which, when requested by the terminal device to transmit data, detects a state of the image processing apparatus; and
a third transmission section which, if the state detection section has detected an abnormal state of the image processing apparatus, transmits a message reporting the abnormal state.

3. The image processing apparatus of claim 1, wherein
the first group and the second group are classified according to updating frequency of management information.

4. The image processing apparatus of claim 1, wherein
the first group and the second group are classified according to frequency of usage of management information.

5. The image processing apparatus of claim 1, wherein
the first group and the second group are classified according to type of managed device.

6. The image processing apparatus of claim 1, further comprising:
an updating section which, when requested by the terminal device to transmit data, updates the management information, wherein
the management information transmitted by the first transmission section is the updated management information.

7. An image processing apparatus comprising:
an XML storage section which stores therein, in XML format, management information that relates to a managed device and is classified into at least a first group and a second group of information, each group of information being stored in a different file from one another;
an XSLT storage section which stores therein, in XSLT format, at least one style sheet that is used for displaying management information;
a first transmission section which, when receiving from a terminal device a transmission request of data used for displaying the first group of information, transmits a first XML file that is in the XML storage section and that contains the first group of information, and transmits a style sheet that is in the XSLT storage section and that corresponds to the first XML file; and
a second transmission section which, when receiving from the terminal device a transmission request of data used for displaying the second group of information, transmits a second XML file that is in the XML storage section and that contains the second group of information.

8. The image processing apparatus of claim 7, wherein
the XSLT storage section stores therein at least a first style sheet that corresponds to the first XML file, and a second style sheet that corresponds to the second XML file,
the first transmission section transmits the first style sheet, as a style sheet that corresponds to the first XML file, and
the second transmission section, in addition to the second XML file, transmits the second style sheet.

9. The image processing apparatus of claim 7, wherein
the XSLT storage section stores one style sheet that corresponds at least to the first XML file and the second XML file, and
the first transmission section transmits the one style sheet corresponding at least to the first XML file and the second XML file, as a style sheet that corresponds to the first XML file.

10. The image processing apparatus of claim 7, further comprising:
a state detection section which, when requested by the terminal device to transmit data, detects a state of the image processing apparatus; and
a third transmission section which, if the state detection section has detected an abnormal state of the image processing apparatus, transmits a message reporting the abnormal state.

11. The image processing apparatus of claim 7, wherein
the first group and the second group are classified according to updating frequency of management information.

12. The image processing apparatus of claim 7, wherein
the first group and the second group are classified according to frequency of usage of management information.

13. The image processing apparatus of claim 7, wherein
the first group and the second group are classified according to type of managed device.

14. The image processing apparatus of claim 7, further comprising:
an updating section which, when requested by the terminal device to transmit data, updates the management information, wherein
the management information transmitted by the first transmission section and the second transmission section is the updated management information.

15. A processing method of management information that relates to a managed device, comprising:
a storing step of storing, in XML format, the management information to an XML storage section, the management information including a first group and a second group of information;
a first transmission step of, when receiving from a terminal device a transmission request of data used for displaying the first group of information, reading the management information from the XML storage section and a first style sheet in XSLT format from a first XSLT storage section, and transmitting the management information and the first style sheet, the first style sheet being used for displaying the first group of information; and
a second transmission step of, when receiving from the terminal device a transmission request of data used for displaying the second group of information, reading from a second XSLT storage section a second style sheet in XSLT format, and transmitting the second style sheet, the second style sheet being used for displaying the second group of information.

16. The processing method of claim 15, further comprising
an updating step of, when requested by the terminal device to transmit data, updating the management information, wherein
the management information transmitted at the first transmission step is the updated management information.

17. A processing method of management information that relates to a managed device, comprising:
a storing step of storing, in XML format, the management information to an XML storage section, the management information being classified into at least a first group and a second group of information, each group of information being stored in a different file from one another;
a first transmission step of, when receiving from a terminal device a transmission request of data used for displaying the first group of information, reading from the XML storage section a first XML file containing the first group of information and a style sheet that corresponds to the first XML file from an XSLT storage section, the style sheet being among at least one style sheet that is stored in the XSLT storage section and is used for displaying management information, and transmitting the first XML file and the style sheet, that have been read; and
a second transmission step of, when receiving from the terminal device a transmission request of data used for displaying the second group of information, reading from the XML storage section a second XML file containing the second group of information, and transmitting the read second XML file.

18. The processing method of claim 17, further comprising
an updating step of, when requested by the terminal device to transmit data, updating the management information, wherein
the management information transmitted at the first transmission step and the second transmission step is the updated management information.

19. A recording medium that data can be read from with use of a computer, and that records therein a program for enabling the computer to pursue functions as an image processing apparatus that treats management information relating to a managed device, the program comprising:
a storing step of storing, in XML format, the management information to an XML storage section, the management information including a first group and a second group of information;
a first transmission step of, when receiving from a terminal device a transmission request of data used for displaying the first group of information, reading the management information from the XML storage section and a first style sheet in XSLT format from a first XSLT storage section, and transmitting the management information and the first style sheet, the first style sheet being used for displaying the first group of information; and
a second transmission step of, when receiving from the terminal device a transmission request of data used for displaying the second group of information, reading from a second XSLT storage section a second style sheet in XSLT format, and transmitting the second style sheet, the second style sheet being used for displaying the second group of information.

20. A recording medium that data can be read from with use of a computer, and that records therein a program for enabling the computer to pursue functions as an image processing apparatus that treats management information relating to a managed device, the program comprising:
a storing step of storing, in XML format, the management information to an XML storage section, the management information being classified into at least a first group and a second group of information, each group of information being stored in a different file from one another;
a first transmission step of, when receiving from a terminal device a transmission request of data used for displaying the first group of information, reading from the XML storage section a first XML file containing the first group of information and a style sheet that corresponds to the first XML file from an XSLT storage section, the style sheet being among at least one style sheet that is stored in the XSLT storage section and is used for displaying management information, and transmitting the first XML file and the style sheet, that have been read; and
a second transmission step of, when receiving from the terminal device a transmission request of data used for displaying the second group of information, reading from the XML storage section a second XML file containing the second group of information, and transmitting the read second XML file.
